(19) United States
(12) Patent Application Publication
(10) Pub. No.: US 2004/0086092 A1
(43) Pub. Date: May 6, 2004

(54) Method and system for emergency communication for high risk residents

(76) Inventor: Van Kirk Fehr, Washington, DC (US)

Correspondence Address: Bradforfd Kile, Suite 475, 655 15th Street, Washington, DC, 20005, US

(21) Appl. No.: 10/615,035

(22) Filed: Jul. 9, 2003

Related U.S. Application Data
(60) Provisional application No. 60/394,251, filed on Jul. 9, 2002.

(51) Int. Cl. H04M 11/04

(52) U.S. Cl. 379/37; 379/45

(57) ABSTRACT

A system and method that is intended to provide at least some of the foregoing objects includes a special telephone system for communicating from and to the physically and or mentally impaired. The system is useful for residents of assisted living centers, or other individuals who might be prone to falls or similar incidents that leave them unable to attend to their needs, at least temporarily, and unable to call for help via conventional telephone systems.

### RELATED PATENTS AND APPLICATIONS

This application claims the benefit of U.S. Provisional Application No. 60/394,251 entitled “Method and System for Emergency Communication for High Risk Residents” filed on Jul. 09, 2002. The Provisional Application is of common inventorship with the subject application.

### BACKGROUND OF THE INVENTION

### FIELD OF THE INVENTION

This invention relates to a method and system for emergency communication for high risk residents such as the elderly, mentally impaired or physically challenged. More specifically this invention relates to a telephone based method and system of communication that can be facilely operated during times of impairment.

As the human population enjoys enhanced medical care and treatment the average age has increased and will continue to increase. At the same time there is an increasing interest in maintaining separate and independent living arrangements. However, as our elderly, mentally impaired and/or physically challenged enjoy the psychological benefits of independent living significant emergencies can be encountered that are correctable but sometimes require immediate attention. As an example, if a person passes out or falls and injures themselves, and they are living alone, calling for emergency assistance in a conventional manner may be impossible. In an incapacitated state an injured person might lie in discomfort for hours or even days until someone even knows that assistance is needed.

Although most living arrangements include standard land line telephone access and even wireless telephone systems and cellular phone systems, in times of emergency it is not always possible for the impaired to reach a telephone instrument. Moreover, a telephone that functions properly might be knocked ajar or “off-hook” or a battery might be dead in a cell phone and would thereafter not function to enable an outside caller to contact the resident without physically visiting the persons home. Such visits might be impractical, if repetitive, or even impossible over long distances.

The difficulties and limitations suggested in the preceding are not intended to be exhaustive, but rather are among many limitations which demonstrate that enhanced emergency assistance methods and systems for the impaired is worthwhile.

### OBJECTS OF THE INVENTION

It is, therefore, a general object of the invention to provide a method for system for emergency communications for high risk residents that will obviate or minimize problems of the type previously described.

It is a specific object of the invention to provide a system and method of enhanced speaker activation by an alarm signal such as “HELP” that will activate a telephone communication or connection to a designated friend, service or care giver.

It is another general object of the invention to provide a system and method for automatically placing a telephone “on-hook” if left “off-hook” for an extended period.

It is a further object of the invention to provide a system and method which will include a special one button emergency, preprogrammed, signal that can be sent by the push of a button or call of alarm via voice recognition commands.

It is still another object of the invention to provide a GPS locator function so that a care giver can determine the location of the call even if made over a cellular or wireless system.

It is yet another object of the invention to provide a method and system to enable an emergency or resident friendly service to call-in and drive a verbal communication.

It is yet still another object of the invention to provide a method and system which will include voice recognition technology to enable secure and reliable communication connections.

It is a further object of the invention to provide a system and method that is rugged and stable and not easily overturned or disrupted with respect to its intended function.

### SUMMARY OF THE INVENTION

A system and method that is intended to provide at least some of the foregoing objects includes a special telephone system for communicating from and to the physically and or mentally impaired. The system is useful for residents of assisted living centers, or other individuals who might be prone to falls or similar incidents that leave them unable to attend to their needs, at least temporarily, and unable to call for help via conventional telephone systems.

### DRAWINGS

Other objects and advantages of the present invention will become apparent from the following detailed description of a preferred embodiment thereof taken in conjunction with the accompanying drawings, wherein:

FIG. 1 is an axonometric view of a service unit in accordance with a preferred embodiment of the invention and illustrates a representative exterior appearance of a communication unit including a speaker mounted at the top, or “north pole,” of a hemisphere, a telephone handset, a key pad, etc. Alternatively, the speaker can be mounted so that it is completely internal to the enclosure;

FIG. 2 is a schematic illustration of the operational electronic components of the subject invention; and

FIG. 3 is an illustration of a special key pad that is depicted in the communication unit of FIG. 1.

### DETAILED DESCRIPTION

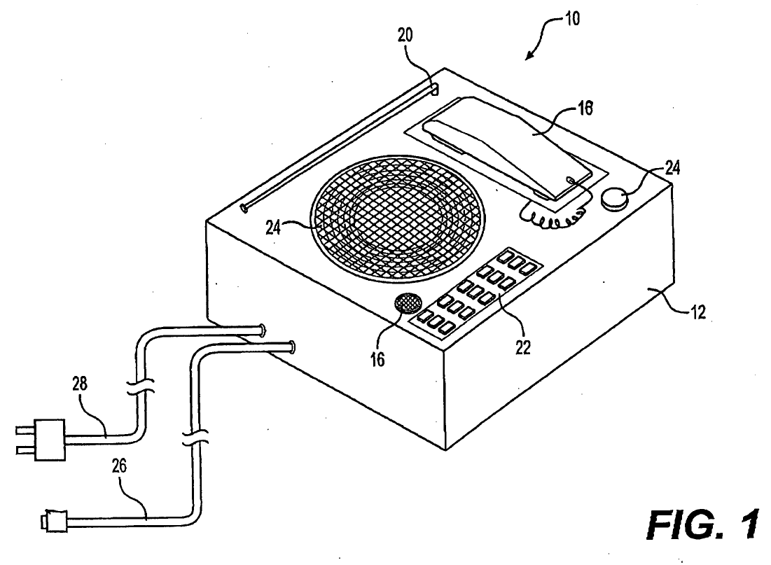

Referring now to the drawings wherein like numerals refer to like parts FIG. 1 discloses a communication unit 10 in accordance with a preferred embodiment of the invention. The communication unit included a substantial, generally square base 12 that houses the electronic components of the subject invention (not shown). A speaker 14 is connected to the base and is large and robust enough to be heard throughout a conventional residence. One or more microphones 16 are built into the base are designed to be sensitive and preferably mni directional to receive voice signals from a person in distress.

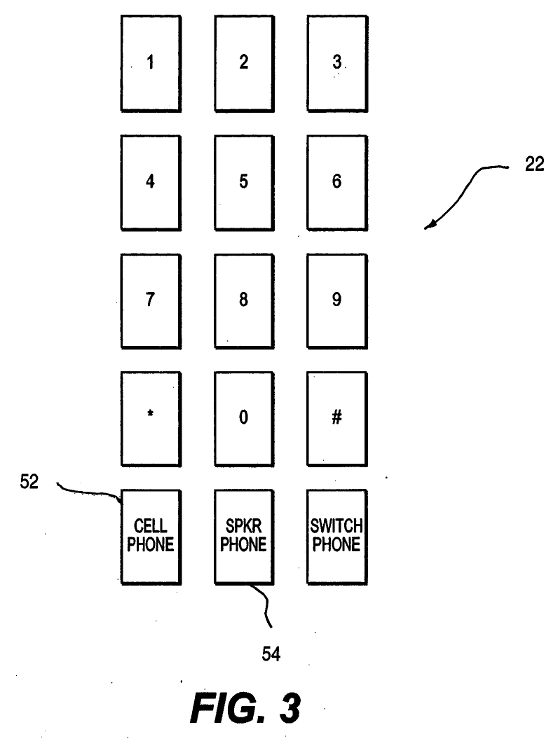

A telephone handset 18 fitted onto the base and is shaped like most common telephone handsets. It rests in the ordinary manner in two depressions on the enclosures which form a cradle. The depression should be located near the top of the enclosure so that the handset rests in a nearly horizontal position and is therefore stable. A common, telephone hook switch is located in the depression used by the earpiece. The handset is connected to the electronics inside the enclosure in the ordinary manner, i.e. via a telephone cord. The communication also included an antenna 20 for wireless communication and a keypad 22. The communication unit also includes 1-button-touch-tone keypad 24. Keypad 22 is shown more specifically in FIG. 3.

The communication unit includes an ordinary RJ-11 port for connection of ordinary twisted pair telephone wire, which is terminated by an RJ-11 plug at either end. (Only the RJ-11 plug on the end that plugs into the wall is shown—the other end is concealed by the enclosure.) The communication includes a power cord 28 for connection to ordinary 120 volt electrical service and an internal battery for automatic emergency service. The power supply and the RJ-11 telephone connection can be located anyplace on the enclosure.

Cell phone antenna 20 is mounted on the telephone enclosures, as is a distress button 24. The user pushes this button to communicate a distress condition, and the telephone electronics react accordingly, as described below.

### Block Diagram of the Electronic Functions

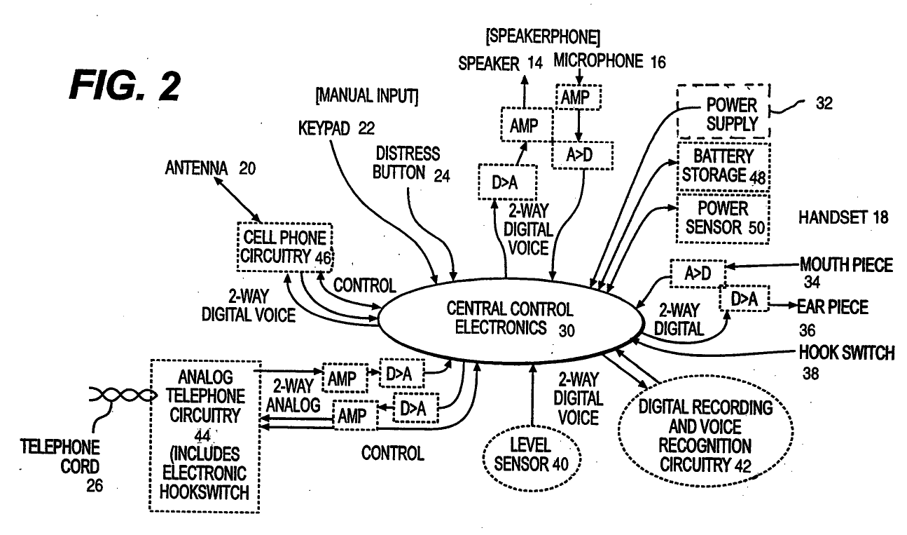

At the center of FIG. 1 is a base 12 that represents the internal electronics of the subject communication unit. The internal components are not the subject of the subject invention per se as they are all components that can be designed and built by one of ordinary skill in the telephone communications art. e. Dashed lines have been included in FIG. 2 between electronic components and the external components, described above. These denote the communication paths over which information and control signals are passed that enable the electronics to manage the function of telephone.

FIG. 2 shows a block diagram of the internal electronics of the base 12. In this central control electronics 30 appears at the center of the diagram. Ringed along the outside are the external components described earlier including a telephone cord 26, a cellular phone antenna 20, a keypad 22, speaker 14, microphone 16, power supply 32, handset 18, and distress button 14. (Handset 18 includes mouthpiece 34, an ear piece 36, and a hook switch 38.) As is seen, there is a direct connection between electronics 30 and each of the power supply 32, button 24, and components of the electronic circuitry.

Beyond control electronics 30, the other major internal electronic components are a level sensor 40, recording circuitry 42, analog telephone circuitry 44, cell phone circuitry 46, battery storage 48, and power sensor 50. The internal components also include several amplifiers, digital to analog converters, (which are denoted by the sequence D>A,) and analog to digital converters, (which are denoted by A>D.)

Level sensor 40 detects the orientation of the telephone with respect to the ground plane. This function can be implemented using known electronic techniques, and the status can be read by electronics 30 over an ordinary communication path. Recording circuitry 42 can record and play back, on command sound signals expressed in digital form. Such a function can also be implemented using known electronic techniques.

Analog telephone circuitry 44 manages a connection to an ordinary telephone line. This circuitry operates in response to digital control signals sent from control electronics 30. It imparts analog sound signals on to the line, and recovers signals from the other end. (A source and destination of these signals must be provided.) It includes an electronic hook switch can also place a telephone line on or off hook in response to changes in digital logic. (An example of an electronic switch hook is one where logic controls an electronic relay to make or break a conductive path. Dialing is accomplished by using its internal circuitry to place touch tones on the line.

Cell phone circuitry 46 provides a link to the local cellular system. When connected to a speaker and microphone, the function of cell phone circuitry 46 is nearly identical to that of a cellular telephone. One difference is that, instead of responding to manual input, it reacts in response to digital signals sent from control electronics 30.

Control electronics 30 receives audio signals from several sources. In each case, however, it inputs these signals in digital form. As a result, sources that provide and/or accept analog audio signals connect with electronics 30 through conversion circuitry that converts the signals to the right form. In particular, analog sound signals are converted to digital form before they are input by control electronics 30, and digital sound signals provided by electronics 30 are converted to analog form. (The appropriate conversion circuitry is shown in the diagram. Amplifiers are required to increase the power of the analog signals after conversion.)

Battery storage unit 48 builds up its charge during periods when power supply 32 is connected. Power sensor 50 detects when power supply 32 is disconnected or when it otherwise fails to provide power to the telephone.

Digital recording and voice recognition circuitry 42 performs two different functions. One function is to store audio signals in digital form and streams these signals back to control electronics 30, on demand, in digital form. As such, circuitry 42 can function much the same way as the circuitry in digital answering machines.

Circuitry 42 can also perform voice recognition analysis on the digital sound signals sent by control electronics 30. (Hardware that performs voice recognition functions is well known.) In particular, it can be useful for circuitry 42 to be programmed to respond to a small set of verbal commands that allows the user to dial the emergency service. This helps a resident in distress to communicate with such a service without actually being within reach of the telephone. (The sound undergoing “recognition”, such as “HELP” would be picked up by microphone 16 and applied, by electronics 30, to circuitry 42.)

### Implementation of Specific Functions

The most basic function of control electronics 30 is to direct the telephone to communicate over an ordinary analog telephone line. Control electronics 30 can do this by establishing a connection between analog telephone circuitry 44 and handset 18. (Such a connection can be made with electronic switches according to known techniques.) This provides circuitry 44 with sound input and a destination for the voice signal recovered from the line. The user initiates such operation by taking handset 18 off-hook. This enables the user to communicate over the ordinary telephone line through the handset. Dialing is accomplished using a keypad 22 in the ordinary manner.

Alternatively, a user can push the “speaker phone” button on keypad 22. This instructs electronics 30 to connect the speakerphone components, i.e. speaker 14 and microphone 16, to circuitry 30, creating the same communication link as provided by ordinary speaker phones. Once again, dialing could be accomplished through the use of keypad 22.

The user can also elect to communicate via the functionality provided by cell phone circuitry 46. This option can be invoked by picking up the handset and pressing the “cell phone” button 52 on keypad 22, note FIG. 3. In response, control electronics 30 would connect mouthpiece 34 of handset 18 to the “audio in” port of circuitry 30, as it would connect earpiece 36 of handset 18 to the port where sound is produced by circuitry 30. Alternatively, the user can elect to use the cell phone connection while speaking and listening via the speaker phone. To elect this option, the user would push the “cell phone” button 52 on the keypad 22, followed by “speaker phone” button 54. In response, control electronics 30 would make the internal connections necessary to make the speaker phone components correspond the acoustic input and output of the telephone.

If, after using the analog phone line in the normal manner, the user fails to place the handset 16 back in the cradle, the telephone will remain off-hook and the telephone line will “go dead” after a few minutes. In this case, the electronic hook switch circuitry 44 will detect and communicate the “dead line” condition to control electronics 30. (Known means can be provided to detect the “dead line” condition,) As described above, such a situation can indicate that the resident is in a situation of distress. When electronics 30 learns of a “dead line” condition, it will initiate a telephone call to the emergency service over the cell phone link, and will signal the service that the user's handset is off-hook. (The telephone number of the emergency service can be stored in electronics 30 using known techniques.) The dialing required to make such a call can be implemented by electronics 30 by reacting as if the necessary keystrokes were delivered to it from keypad 22. This call is made via the speaker phone connection, (i.e. by connecting the speaker phone components to circuitry 46) so that the service can control the speaker and try to alert or speak with the resident.

Electronics 30 will also call the emergency service if the resident presses distress button 24. As mentioned above, a certain advantage is derived if distress button 24 is equipped with a remote-control capability. In other words, there is an advantage to providing the resident with a small transmitter that communicates, in a wireless manner, with button 24 or via a voice activated switch by verbally signaling “HELP.” In particular, such a capability will allow the resident to invoke the distress button even if he or she is immobile and cannot reach the phone.

When circuitry 44 detects that the line is dead, electronics 30 can also use the ordinary telephone line to report to the emergency service that the resident left his or her handset off the hook. In this case, electronics 30 instructs the electronic hook switch in circuitry 44 to place the telephone “on-hook” even if handset 18 has not been put back in its cradle. This will restore the dial tone to the analog telephone line, and then intelligence in electronics 30 can direct this hook switch to go “off-hook”, and call the emergency service using the speakerphone capability. Thus, the important function of contacting an emergency service when a resident has left the phone off the hook can be provided even without including cell phone functionality.

Control electronics 30 is also provided with the ability for an outside caller to dial in, force the telephone off-hook, and gain control of the telephone, even without the cooperation of the resident. This ability allows the caller to try to speak with the resident who may not be able to get to or pick up the handset. It call also allow the caller to listen to the resident, and to play back the sounds recorded earlier by digital recording circuitry 42. This can be useful when the user seems to be in distress, because there may be a certain advantage for the emergency service to be able to call up and listen to the sounds in the dwelling. (These sounds, presumably, would have been created over the preceding few minutes.)

When providing the foregoing functions, it is important to prevent random or malicious callers from taking control of the telephone. To provide this protection, central electronics 30 can be programmed, using ordinary techniques, to match up the caller ID information of every call with a number stored in its memory. If the two numbers did not match, the telephone would not answer.

Finally, control electronics 30 must respond when it receives a signal from power sensor 50 that the power to the telephone has been suspended. (As mentioned above, the telephone begins to derive power from the battery 48 when this happens.) The response is to dial the emergency service and report the condition. A report is also given when level sensor 40 reports that the telephone is not lying horizontally.

### SUMMARY OF MAJOR ADVANTAGES OF THE INVENTION

After reading and understanding the foregoing description f the invention, in conjunction with the illustrative drawings, it will be appreciated that several advantages of the subject method and system are obtained. The capabilities of the special telephone system include:

a) The telephone includes an ordinary handset and dial pad that allows the user to communicate in the normal manner, and it also includes a speaker, and a sensitive, omni-directional microphone so that it can be used as a speakerphone.

b) The telephone includes the necessary electronics to communicate over an ordinary copper telephone line, and it also includes cell phone electronics so that it can connect and use the local cellular system in the ordinary manner. The user can elect which mode (i.e. standard or cell phone) to use, and can use the speakerphone function (i.e. the speaker and sensitive microphone) or the ordinary handset in either mode.

c) The telephone would be designed to go on-hook, i.e. to hang up if left unattended in an off-hook condition for some time. The telephone would detect when it was left in this condition and, after it created the on-hook condition, it would automatically call an emergency service center in response. The cell phone connection would for this function. (Special electronics are provided for the telephone to use standard wired connection in the event that the cell link is not functional.) The service center would understand that the resident had left the telephone off-hook. Because this might be a sign of distress, the center would then call the resident to see if they are OK. They would also tell the resident, of course, to put the handset back on-hook.

d) A special-function button is mounted on the housing of the telephone. When pushed, this button would prompt the telephone to dial up a pre-programmed number. Ordinarily, this number would correspond to some emergency-response service. In that case, the button would allow a resident to “summon help with one push.” This would be useful for residents that might ordinarily struggle to find the emergency number and dial it. Optionally, the user would be provided with a means to pass this “emergency” signal to the telephone from a distance that exceeds the longest distance in ordinary residences.

e) The telephone includes a special capability that may help an emergency service reach the resident who can speak but could not answer the phone. The telephone is designed so that a special party can dial in and force the telephone to go off-book. That way, an emergency service can drive the speaker and activate the microphone and may be able to communicate with such a resident. To prevent arbitrary callers from forcing an off-hook condition, the telephone will be designed to react to the caller-id information that is sent with every call. Only calls that originated from a special telephone number would be able to force the off-hook condition. Note that, in the foregoing situation, the resident might not be able to get close to the microphone. As a result, the microphone must have high sensitivity.

f) The telephone is powered by a standard connection to the 120V power line so it would not run out of power. It also has a battery that is kept charged by the 120V. If the resident disconnects the power, the telephone switched to battery power and waits a period of time to give the resident an opportunity to reconnect. If the telephone is not reconnected, it reminds the user with a message from its speaker. If the resident still does not reconnect, the telephone dials an emergency service and reports the event.

g) The telephone is also equipped with voice-recognition technology and with a recording capability. The voice-recognition technology enables the resident who could speak but not physically reach the phone to orally instruct the telephone to dial emergency services. The recording capability picks up and stores the last 20 seconds of sound in the residence. Then, if the emergency service has reason to believe the resident needs help but cannot answer the telephone, it can dial in to check the last 20 seconds of sound in the residence. This can give the service some indication of whether the resident needs help or not.

h) The telephone electronics are enclosed in a very large housing. In the preferred embodiment, the dimensions of the housing would be approximately one foot square and three inches high. The large housing discourages the user from stowing the telephone away where it is not useful.

i) In the preferred embodiment, the telephone has a large base and a rounded top, somewhat like a hemisphere resting on its flat side. Such a shape makes the telephone less likely to change orientation in response to an accidental blow or similar event.

j) A mechanism internal to the telephone detects when the flat side of the telephone is no longer perpendicular to the pull of gravity. When this mechanism detects that such a condition has existed for a minimum period of time, the internal control system directs the cellular function to dial the emergency service.

In describing the invention, reference has been made to a preferred embodiment and illustrative advantages of the invention. Those of skill in the art, however, and familiar with the instant disclosure of the subject invention may recognize additions, deletions, modifications, substitutions and other changes which will fall within the purview of the subject invention set forth in the following claims.

What is claimed is:

1. A system for emergency communication for high-risk residents comprising:
a base unit;
a plain old telephone service “POTS” telephone handset connected to said base unit;
a telephone keypad connected to said base unit;
telephone circuitry operable to establish two way telephone service over a twisted pair of POTS wiring;
telephone circuitry within said base unit operable to establish two way wireless telephone service; and
control electronics connected to said base unit for selectively switching between said POTS service and said wireless telephone service.

2. A system for emergency communication for high-risk residents as defined in claim 1 and further comprising:
a speaker telephone connected to said base; and
circuitry within said control electronics to activate said speaker telephone system.

3. A system for emergency communication for high-risk residents as defined in claim 2 wherein:
said circuitry includes circuitry to activate said speaker telephone system by voice commands.

4. A system for emergency communication for high-risk residents as defined in claim 1 and further comprising:
digital recording and voice recognition circuitry connected to said control electronics operable to activate said emergency communication system from a location remote from said base unit.

5. A system for emergency communication for high-risk residents as defined in claim 1 and further comprising:
a distress button connected to said base unit and being operable to connect to an emergency service via a wireless telephone service upon depressing the distress button.

6. A system for emergency communication for high-risk residents as deemed in claim 1 and further comprising:
a level sensor circuit connected to said base unit operable to detect a condition of the base unit being disposed in a non-horizontal condition;
and
circuitry operable to contact an emergency service in the event the base unit is in a non-horizontal condition.

7. A system for emergency communication for high-risk residents as defined in claim 1 and further comprising:
circuitry operable to detect a dead line condition of said handset; and
circuitry to initiate a telephone call to an emergency service to alert the service of the dead line condition.

8. A system for emergency communication for high-risk residents as defined in claim 7 and further comprising:
circuitry to wireless voice communication with a resident by an emergency service in the event an off-hood condition is detected.

9. A method f r establishing emergency communication for high risk residents comprising the steps of:
providing a plain old telephone service(“POTS”) into a residence;
providing a wireless telephone service into the residence associated with said POTS service; and
in the event of a dead line condition of said POTS service establishing a wireless telephone signal to an emergency service alerting the emergency service of the dead line condition of the POTS service.

10. A method for establishing emergency communication for high risk residents comprising the steps of:
providing a plain old telephone service(“POTS”) into a residence with a base unit;
providing a wireless telephone service into the residence associated with said POTS service and through said base unit;
detecting the level condition of said base unit; and
in the event that the base unit is determined to be not level contacting an emergency service via said wireless telephone service.
